(19) United States
(12) Patent Application Publication
(10) Pub. No.: US 2005/0105229 A1
(43) Pub. Date: May 19, 2005

(54) Two-level protection for uninterrupted power supply

(75) Inventors: Duo Deng, Canton, MI (US); Kenneth J. Farkas, Brighton, MI (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Ballard Power Systems Corportion, Dearborn, MI (US)

(21) Appl. No.: 10/713,552

(22) Filed: Nov. 14, 2003

(51) Int. Cl. H02H 3/20

(52) U.S. Cl. 361/90

(57) ABSTRACT

Method and apparatus for determining transient power source defects versus nontransient, grid failures result in power being selectively applied to a DC bus for application to a load by either the power source, a rechargeable DC power supply, or both. The severity of the power interruption determines the degree to which the power will be supplied to a load through a power converter assembly by either an AC source or a rechargeable DC power supply.

### BACKGROUND OF THE INVENTION

1. Field of the Invention

The present disclosure relates to uninterruptible power supply systems. More specifically, the disclosure relates to methods and apparatus for detecting irregularities in an electrical power source for which the uninterruptible power supply is a backup, such as for a three-phase alternating current public power grid.

2. Description of the Related Art

Electric power converter systems are used to transform and/or condition electrical power in a variety of applications. For example, electrical power converter systems may transform AC power from a power grid to a form suitable for a standalone application (e.g., powering an electric motor, lights, electric heater, household or commercial equipment, telecommunications equipment, computing equipment, uninterruptible power supply (hereinafter, occasionally “UPS”)). UPS systems have become extremely important as backup power supplies for use by hospitals, financial institutions, industrial sites and the like during interruptions of the public three-phase power supply grid. Increasingly, domestic home owners also rely on UPS systems to supplement and/or replace power from the public power grid during grid failures.

UPS systems typically incorporate some type of electrical power converter system. An electrical power converter system may comprise one or more subsystems such as an DC/AC inverter, DC/DC converter, and/or AC/DC rectifier. Typically, electrical power converter systems will include additional circuitry and/or programs for controlling the various subsystems; and for performing switching, filtering, noise and transient suppression, and device protection.

By way of example and historical explanation, converter systems initially were purpose-built for specific applications. One early type of power converter was specifically designed for inverting direct current, constant voltage sources (e.g., batteries) to alternating current outputs (e.g., for operation of AC motors). Converters of this type are termed “inverters” and they have been in the simple form of transformers interconnecting a DC power supply with a plurality of logic control switches to generate the necessary alternating current waveform. A rectifier is another type of power converter for converting alternating current to direct current. Rectifiers have proven themselves especially useful for adapting household 110 volt alternating current to 12-volt direct current for operation of battery-powered appliances. Devices of this type have been as simple as a step-down transformer connected to a diode bridge and a smoothing capacitor for full-wave rectification. U.S. Pat. No. 6,021,052 to Unger et al. entitled “DC/AC Power Converter,” issued on Feb. 1, 2000, disclosed a more sophisticated implementation of an AC to DC rectifier, including discrete components (both analog and digital) for converting direct current power to alternating current power, suitable for driving an AC load which is otherwise in series with an AC power supply. Separately, direct current to direct current (hereinafter occasionally “DC-DC”) converters have been provided for conditioning direct current power from a variable power source (e.g., a wind-driven direct current motor, photovoltaic panel or the like) for charging a battery or array of batteries.

So-called uninterruptible power supplies have been developed which permit power to be converted from a direct current power supply to a three-phase AC load in the event of a failure of the AC grid, and for recharging the DC power supply from the AC grid through the same apparatus when the AC grid is not in a failure mode. The UPS device disclosed by Unger et al. is capable of adapting to a variety of DC power sources by converting the variable DC input to a desired DC voltage on a DC bus. A separate system then converts the now regulated DC voltage on the DC bus into AC power for interfacing with an AC source (e.g., the AC power grid) or upon operation of a transfer switch, an AC load (such as a motor) in the event of a grid failure. Nevertheless, as best understood, the device and topology disclosed by Unger et al. is not readily modified for intelligent detection of electrical power source irregularities (e.g., a public power grid failure). Attention is directed to column 40, lines 39-50 of Unger et al., which appears to disclose that various subsystems of the device disclosed therein may be shut off when the AC source is unable to supply power such that the device disclosed by Unger et al. may act as an uninterruptible power supply. Furthermore, Unger et al. fail to disclose any means for automatically detecting either general or specific irregularities in the public power grid, or for automatically actuating uninterruptible power supply systems so as to disconnect the AC load from the AC source, and for connecting the AC load to the DC/AC converter.

U.S. Pat. No. 5,684,686 to Reddy entitled “Boost-Interrupt Backed-Up Uninterruptible Power Supply,” issued on Nov. 4, 1997, discloses a more sophisticated uninterruptible power supply for use with an alternating current, two-phase power main, such as household electrical power service. Reddy discloses at column 7, lines 1-14 that a microprocessor in combination with corresponding analog and digital signal conditioning circuitry monitors various performance parameters for the purpose of detecting a failure. Without further explanation, Reddy states that at the onset of a failure, the microprocessor controller actuates a relay 84 to supply power to an output load 14 from the uninterruptible power supply 10. However, Reddy fails to disclose any specific logic for detecting a failure, nor for defining a failure. Furthermore, the system disclosed by Reddy appears to only provide two modes of operation: a first mode in which all of the power to the load is supplied by the two-phase public power system; or, a second mode in which all of the power to the load is supplied by the uninterruptible power supply system. Those of ordinary skill in the art are aware that irregularities in an electrical power source (whether the public power grid or an on-site diesel engine/generator combination) are not of a single type. Although it is known that the public power system can fail in its entirety (e.g., a blackout), a variety of other modes of failure are also possible. It is known, for example, that the public power grid can brownout, in which three-phase alternating power is delivered at a voltage magnitude less than standard, but nevertheless non-zero in magnitude. Furthermore, power irregularities (particularly from diesel engine/generator systems) may provide three-phase alternating current power of appropriate voltage magnitude, but in an incorrect phase relationship, or comprising a single phase operating at an improper frequency. Finally, any of the above power source irregularities may be only transitory in nature, lasting only a few seconds, or even a fraction of a second. Clearly, human intervention will not suffice for manually, electrically connecting and disconnecting an uninterruptible power supply to a load during such transient defects. Nevertheless, certain loads (various institutions which rely heavily on computer data processing, such as financial institutions) have little tolerance for even temporary, transient faults in their power supply.

Thus, a need exists for methods and apparatus applicable to uninterruptible power supplies which can distinguish between various different types of power source irregularities in terms of quality, magnitude, and duration.

A further need exists for methods and apparatus applicable to uninterruptible power supply systems for intelligently utilizing backup power from a direct current power supply for application to a load connected to the uninterruptible power supply according to the quality, magnitude, and duration of the irregularity in the electrical power source.

### BRIEF SUMMARY OF THE INVENTION

In one aspect, a method for responding to electrical power source irregularities in an uninterruptible power supply system utilizing a rechargeable DC power supply as back up power comprises providing an uninterruptible power supply system comprising a three phase AC source converter connectable to a three phase AC power source and a three phase AC load converter connectable to a three phase load, wherein the converters are interconnected by a DC bus; monitoring DC bus voltage on the DC bus; establishing a first DC bus voltage threshold indicative of a first power source irregularity and a second DC bus voltage threshold indicative of a second and distinct power source irregularity, wherein the first threshold is greater than the second threshold; comparing the DC bus voltage to the first and second thresholds; commuting electrical power from both the power source and from the DC power supply to the DC bus when the DC bus voltage is intermediate the first and second thresholds; and, conversely commuting electrical power only from the DC power supply to the DC bus when the DC bus voltage is less than the second threshold, and disabling the source converter.

In another aspect, an apparatus for responding to electrical power source irregularities in an uninterruptible power supply system comprising a rechargeable DC power supply interconnected to a DC bus comprises an uninterruptible power supply system comprising a three phase AC source converter connectable to a three phase AC power source and a three phase AC load converter connectable to a three phase load, wherein the converters are interconnected by a DC bus; means for monitoring DC bus voltage on the DC bus; establishing means for establishing a first DC bus voltage threshold indicative of a first power source irregularity and a second DC bus voltage threshold indicative of a second and distinct power source irregularity, wherein the first threshold is greater than the second threshold; comparing means for comparing the DC bus voltage to the first and second thresholds; and commuting means for commuting electrical power from both the power source and from the DC power supply to the DC bus when the DC bus voltage is intermediate the first and second thresholds, and for conversely commuting electrical power only from the DC power supply to the DC bus when the DC bus voltage is less than the second threshold and for disabling the source converter.

In a further aspect, a method for responding to electrical power source irregularities in an uninterruptible power supply system comprises providing an uninterruptible power supply system comprising an AC source converter connectable to an AC power source and an AC load converter connectable to a load, wherein the converters are interconnected by a DC bus; interconnecting a rechargeable DC power supply to the DC bus; monitoring DC bus voltage on the DC bus; establishing a first DC bus voltage threshold indicative of a first power source irregularity and a second DC bus voltage threshold indicative of a second and distinct power source irregularity, wherein the first threshold is greater than the second threshold; comparing the DC bus voltage to the first and second thresholds; commuting electrical power from both the power source and from the DC power supply to the DC bus when the DC bus voltage is intermediate the first and second thresholds; and, conversely commuting electrical power only from the DC power supply to the DC bus when the DC bus voltage is less than the second threshold, and disabling the source converter.

In still a further aspect, an apparatus for responding to electrical power source irregularities in an uninterruptible power supply system comprising a rechargeable DC power supply interconnected to a DC bus comprises an uninterruptible power supply system comprising a three phase AC source converter connectable to a three phase AC power source and a three phase AC load converter connectable to a three phase load, wherein the converters are interconnected by a DC bus; a number of voltage sensors coupled to sense DC bus voltage on the DC bus; a controller configured to compare the DC bus voltage to a first DC bus voltage threshold indicative of a first power source irregularity and a second DC bus voltage threshold indicative of a second and distinct power source irregularity, wherein the first threshold is greater than the second threshold; and further configured to provide control signals to at least one of the three phase AC source converter and the three phase AC load converter to commutate electrical power from both the power source and from the DC power supply to the DC bus when the DC bus voltage is intermediate the first and second thresholds, and for conversely commuting electrical power only from the DC power supply to the DC bus when the DC bus voltage is less than the second threshold and for disabling the source converter.

### BRIEF DESCRIPTION OF THE SEVERAL VIEWS OF THE DRAWING(S)

FIG. 1 is a schematic representation of one embodiment of an uninterruptible power supply system employing the principles of the present disclosure.

FIG. 2 is a schematic representation of decision logic employed by one embodiment of the system described in the present disclosure for calculating an intermediate current demand by the load.

FIG. 3 is a schematic representation of a logic flow diagram illustrating logical decisions made by one embodiment of the system of the present disclosure for determining whether an electrical power source irregularity is transitory or represents a power source failure.

FIG. 4 is a logic flow diagram completing the logic flow from FIG. 2 for producing command signals to a DC/DC converter based on the average current demanded by the load in the event of a transitory power source irregularity.

FIG. 5 is a logic flow diagram illustrating a process for providing command signals to a DC/DC controller in the event of either a transitory irregularity in the electrical power source, or a power source failure.

FIG. 6 is a component level schematic diagram of first and second converters interconnected by a DC bus comprising a symmetrical topology employed by the uninterruptible power supply system of FIG. 1.

### DETAILED DESCRIPTION OF THE INVENTION

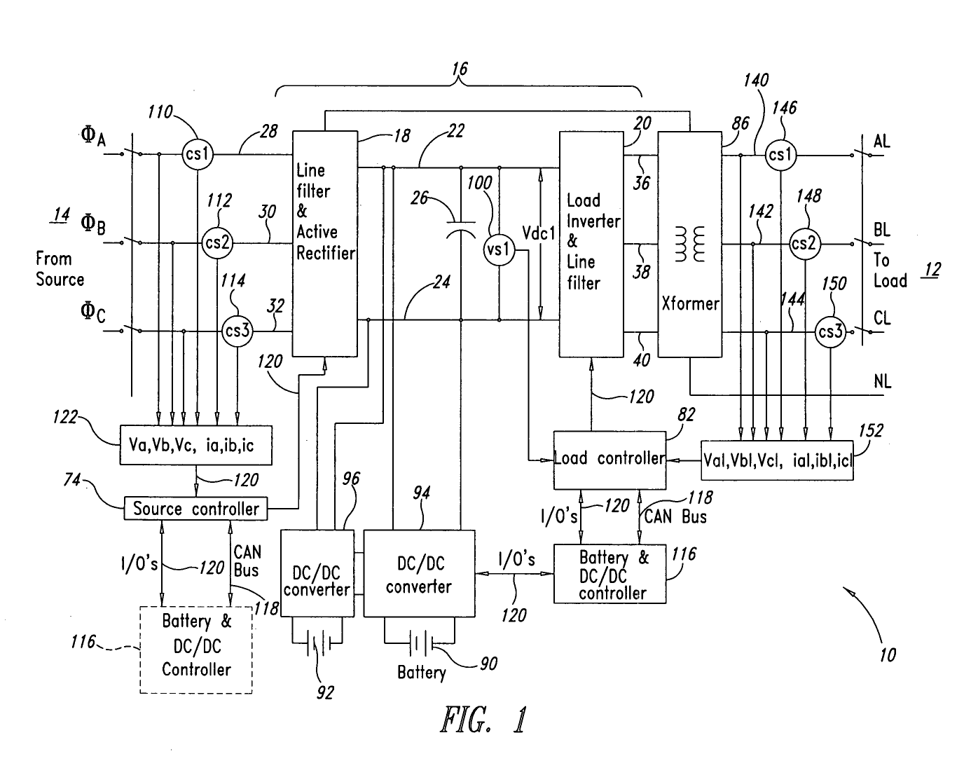

One embodiment of a UPS system employing the principles of the present disclosure is generally indicated at reference numeral 10 in FIG. 1 wherein reference numerals herein correspond to like-numbered elements in the various Figures. In the following discussion, certain specific details are set forth in order to provide a thorough understanding of various embodiments of the present systems and methods. However, one of ordinary skill in the art will understand that the present systems and methods may be practiced without these details. In other instances, well-known structures associated with power converter systems have not been shown or described in order to avoid unnecessarily obscuring descriptions of embodiments of the present systems and methods, unless the context requires. Otherwise, throughout the specification and claims which follow, the word “comprise” and variations thereof, such as “comprises” and “comprising,” are to be construed in an open and inclusive sense, that is as “including, but not limited to.” Reference throughout the specification to “one embodiment” or “an embodiment” means that a particular feature, structure, or characteristic described in connection with the embodiment is included in at least one embodiment of the present systems and methods. Thus, the appearances of the phrase “in one embodiment” or “in an embodiment” in various places throughout the specification are not necessarily referring to the same embodiment. Headings are provided herein for convenience only and do not interpret or limit the scope or meaning of the claimed invention.

In one aspect, the present disclosure teaches a method and apparatus applicable to uninterruptible power supplies which can distinguish between various different types of power source irregularities in terms of quality, magnitude, and duration.

In another aspect, the present disclosure teaches methods and apparatus applicable to uninterruptible power supply systems for intelligently utilizing backup power from a direct current power supply for application to a load connected to the uninterruptible power supply according to the quality, magnitude, and duration of the irregularity in the electrical power source.

In still a further aspect, the present disclosure teaches a method for responding to electrical power source irregularities in an uninterruptible power supply system by providing a source converter connectible to an electrical power source (e.g., the public power grid) and a load converter connectible to a load, wherein the converters are interconnected by a DC bus. A rechargeable DC power supply is connected to the DC bus, and voltage on the DC bus is monitored. First and second DC bus voltage thresholds are established wherein the first threshold is indicative of a first power source irregularity, and the second threshold is indicative of a second and distinct power source irregularity. Instantaneous DC bus voltage which is between the first and second thresholds may be indicative of a transient power source irregularity, whereas DC bus voltage below the second threshold may be indicative of a nontransitory power supply failure. The monitored DC bus voltage is compared to the first and second thresholds. If the DC bus voltage is intermediate the first and second thresholds, electrical power both from the electrical power source experiencing the irregularity and power from the DC power supply are combined to satisfy the requirements of the load and are supplied to the load converter. Conversely, if the DC bus voltage is less in the second threshold, the source converter is disabled (thus isolating the system from the power source irregularity) and only power from the DC power supply is provided to the DC bus for subsequent conversion by the load converter for application to the load.

In one or more embodiments, power source voltage and current parameters for each and any phase on an input side of the source converter are monitored. Predetermined quality criteria for acceptable power source quality are established and the monitored power source parameters are compared to the predetermined quality criteria. If the power source quality fails to meet the predetermined quality criteria, a nontransient power source failure is indicated, and electrical power is commuted only from the DC power supply to the DC bus for conversion by the load converter and application to the load.

In any of the above events, instantaneous load voltage and current parameters for each and any phase on an output side of the load converter may also be monitored. A load power demand value may be calculated from these instantaneous parameters, and when a transient power supply irregularity is indicated, a command signal may be generated and sent to the DC power supply, which is indicative of additional current needed by the load to supplant power lost from the AC power source due to the irregularity.

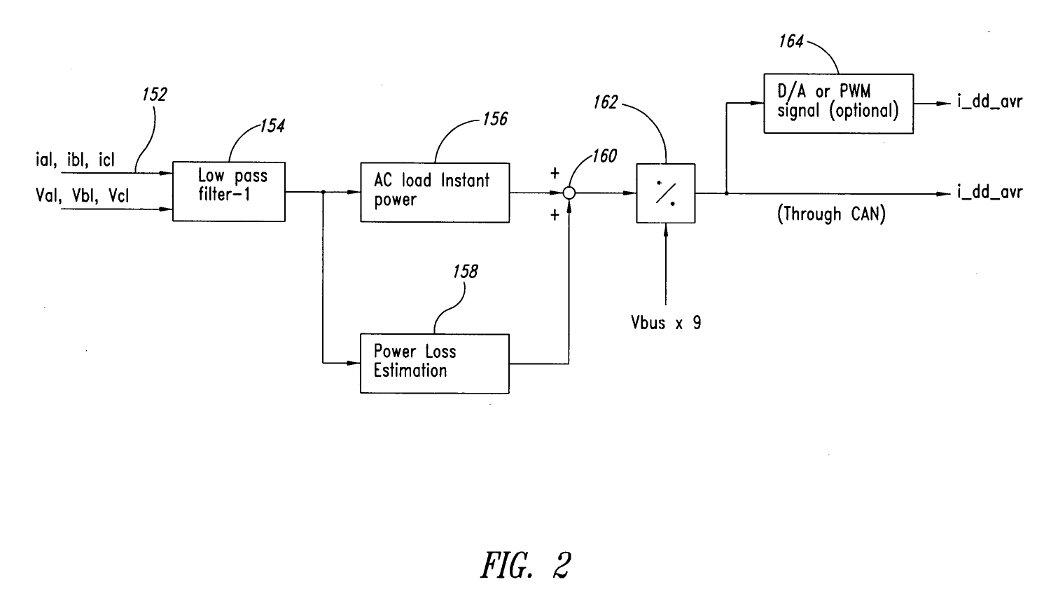

The uninterruptible power supply system 10 is useful for connecting a three-phase load 12 (e.g., a hospital emergency power main) to a three-phase power source 14 such as the public power system. The uninterruptible power supply system 10 advantageously utilizes a power converter assembly generally indicated at reference numeral 16 and shown in greater detail in FIG. 2. The power converter assembly 16 comprises a three-phase first converter (or power source rectifier) 18 and a three-phase second converter (or load inverter) 20 which are interconnected by a DC bus having conductors 22, 24. A capacitor bank 26 interconnects DC bus conductors 22, 24 to minimize transient DC signals between the first and second converters 18, 20.

Each converter 18, 20 comprises three-phase input/outputs 28, 30, 32 and 36, 38, 40 associated with three phases φ_{A}, φ_{B}, and φ_{C}. Each converter has the ability to accept three-phase alternating current signals and to rectify the same for application to the DC bus conductors 22, 24. Such rectification may be passive (i.e., full-wave rectification at the magnitude of the input voltage) or active wherein the resulting DC signal has a voltage in excess of the alternating current input amplitude provided that the power converter is associated with a conventional inductor (not shown) with respect to each phase.

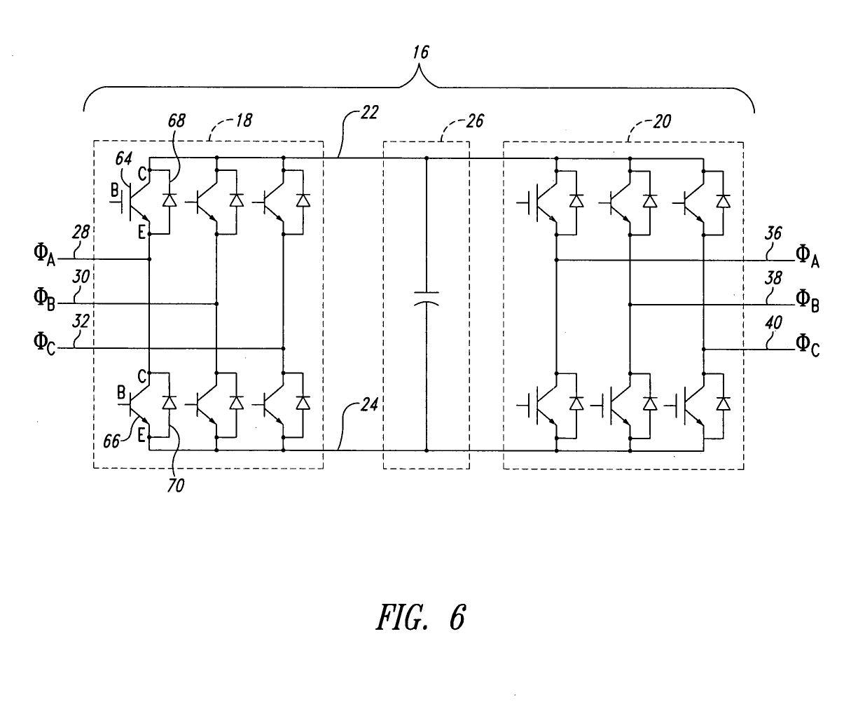

A power converter assembly 16 of the type shown in FIGS. 1 and 6 is-described in detail in U.S. Pat. No. 6,603,672 to Deng et al., entitled “Power Converter System,” issued Aug. 5, 2003, the disclosure of which is incorporated herein by reference.

It is sufficient for the purposes of this disclosure, and with reference to FIG. 6, to indicate that each converter 18, 20 comprises a pair of integrated gate bipolar transistors 64, 66 connected as an emitter-collector pair and connected between the DC bus conductors 22, 24. Such a pair is associated with each phase, φ_{A}, φ_{B}, φ_{C}. Each transistor 64, 66 includes an associated shunt diode 68, 70 having its respective anode connected to the emitter of each transistor 64, 66, and its respective cathode connected to each collector of each transistor 64, 66. Each gate of the transistor pairs associated with first converter 18 is operatively coupled through a first converter gate drive (conventional and not shown) to a first controller (or source rectifier controller) 74. Similarly, each gate of the integrated gate bipolar transistors associated with the second converter 20 is operatively connected through a second converter gate drive (conventional and not shown) to a second controller (or load inverter controller) 82.

The controllers 74, 82 communicate with one another through an internal control area network, an interface terminal block board, and an interface unit (all conventional and not shown) so that the activation of the transistor gates can be coordinated and operated according to a preprogrammed sequence in a manner well known to those of ordinary skill in the art. Briefly stated, whenever the gates of the transistors associated with either of the first or second converter 18, 20 are deactivated, the converters act as a full-wave rectifying diode bridge providing passive rectification of three-phase power which might appear on φ_{A}, φ_{B}, and φ_{C}. When the gates are activated according to a preprogrammed pulse width modulation (PWM) sequence, three-phase alternating current signals which might appear on φ_{A}, φ_{B}, and φ_{C} can be boost rectified (sometimes termed active rectification) to a larger magnitude direct current voltage on the DC bus 22, 24, than the magnitude of the alternating current input signal. Finally, the gates of the transistors of either first or second controller 18, 20 can be operated such that DC power appearing across the DC bus conductors 22, 24 can be converted into three-phase, alternating current voltage on any of the input/outputs 28, 30, 32 or 36, 38, 40 again using pulse width modulation under instructions from the first and second controller 74, 82. It is to be understood that each of these modes of operation are not necessarily used when the power converter assembly 16 is adapted for use with respect to a specific application as opposed to a more generic application such as the alternating current power source 14 and load 12. A conventional Delta-Y isolation transformer 86 preferably interconnects the load inverter 20 to the load 12.

Those of ordinary skill in the art will appreciate that the symmetrical arrangement of the first and second power converters 18, 20 on each side of the DC bus provides conditioned, regulated DC voltage to be drawn from the DC bus, or supplied to the DC bus from a variety of AC sources, to a variety of AC loads (e.g., from the public power grid to an emergency power main for a financial institution or hospital).

With respect to the embodiment shown in FIG. 1, the UPS system 10 has been adapted for interconnecting an electrical power source 14 (such as the three-phase AC power grid, or a diesel engine/generator combination), to a three-phase load 12 (e.g., a bank, hospital, etc.) with a plurality of direct current power supplies 90, 92 operatively connected to respective DC/DC converters 94, 96. The direct current power supplies 90, 92 may be in the form of batteries, or any other suitable rechargeable DC power supply. It is to be understood that the DC/DC converters 94, 96 are connected in parallel to one another and to the DC bus conductors 22, 24, and that any number of DC/DC converter-DC power supply pairs may be connected in parallel to the DC bus. The DC/DC converters also preferably are operatively interconnected with one another for communication purposes, which will become apparent from the discussion further below.

The UPS system 10 thus has the ability to supply the load 12 with power (through the DC bus) from either the power source 14 or the DC power supplies 90, 92, or both, depending on the severity and quality of any irregularities which are detected in the electrical power source 14. In order to monitor those irregularities, the DC bus is provided with a voltage sensor 100, and the inputs/outputs 28, 30 and 32 of the source rectifier 18 are provided with current sensors 110, 112 and 114 associated with each phase φ_{A}, φ_{B}, and φ_{C}. Voltage is also monitored with respect to each phase of the source 14 input and is communicated to the source controller 74 as well as to a battery and DC/DC controller 116. Such communications preferably occur through the control area network bus 118 as well as digital and/or analog input/outputs 120.

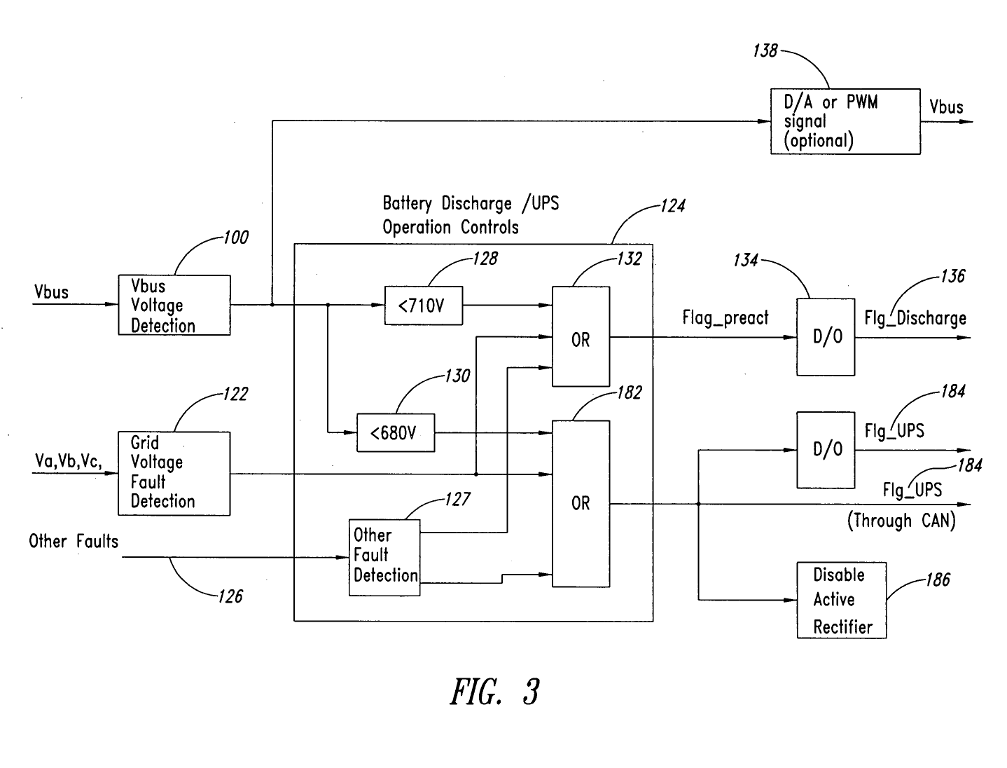

FIG. 3 illustrates logic flow implemented in a conventional microprocessor, microcontroller, or the like (not shown) establishing commands forwarded to the battery and DC/DC controller 116, source controller 74, and load controller 82. The logic flow shown in FIG. 3 distinguishes between intermittent or transitory irregularity in the electrical power source 14 (internally understood by the system 10 as a “discharge event”) and a likely nontransitory, failure of the electrical power source 14 (internally understood by the system as a “UPS event”). During a discharge event, the logic flow shown in FIG. 3 sets a logical flag to logical 1 and power will be drawn both from the batteries 90, 92 under control of the DC/DC converters 94, 96 as well as from the electrical power source 14. Upon detecting a UPS event, the system 10 sets a logical UPS flag to logical 1. If a UPS event is detected, the source rectifier 18 is disabled, and all power to the load 12 is supplied from the batteries 90, 92 and the DC/DC converters 94, 96.

With specific reference to FIG. 3, the DC bus voltage is monitored at voltage sensor 100 and instantaneous electrical power source voltage and current with respect to each phase is separately monitored at monitor 122. Battery discharge/UPS operation controller 124 accepts information regarding the DC bus voltage from voltage sensor100 and the power source voltage and current information from monitor 122. In addition, other faults 126 such as power source phase, frequency, etc. can be accepted by an appropriate fault detection mechanism 127 of the battery discharge/UPS operation controller 124. Internal decision logic of the controller 124 includes a comparison of the instantaneous DC bus voltage from voltage sensor 100 with a first DC bus voltage threshold 128 and a second DC bus voltage threshold 130. In one embodiment of the present systems and methods, normal DC bus voltage is established and controlled by the source rectifier 18 at approximately 750 volts DC. Should the DC bus voltage fall below 710 volts (the first DC bus voltage threshold) for a limited period of time (on the order of milliseconds), or should the monitored power source voltage and current magnitude fall below a first threshold (e.g., 90% of nominal), or should another transitory fault related to frequency or phase be detected, a disjunctive decision 132 is made to provide a digital output 134 setting the discharge flag 136 to a logical 1. The digital flag is communicated to the DC/DC converters 94 and the source rectifier 18 through the control area network bus 118. Operationally, the DC bus voltage detected at voltage sensor 100 can be converted by a digital-to-analog converter to an analog signal (or pulse width modulated signal) 138 outside of the control area network 118 through the digital or analog input/outputs 120 so as to avoid the time delays associated with digital communication.

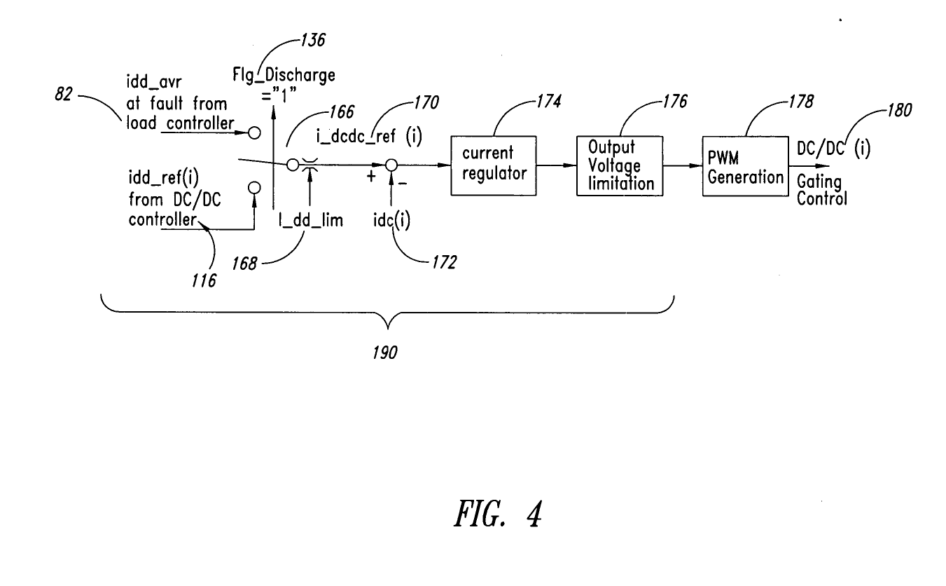

During a discharge event, in which the system 10 indicates a transient irregularity in the power source 14, power from both the power source 14 and the batteries 90, 92 are supplied to the DC bus to restore the DC bus voltage to approximately 750 volts. In order to achieve this result, the current demanded by the load 12 must be calculated so as to instruct the DC/DC converters 94, 96 as to how much power (i.e., voltage and current) should be supplied to the DC bus based on the power required by the load 12. FIGS. 2 and 4 illustrate the logic utilized by the system 10 in both calculating the power requirement of the load at the time the transient power source irregularity is indicated, as well as the specific calculations and logic utilized to generate control signals for the DC/DC converters 94, 96 at the occurrence of a discharge event.

Specifically with reference to FIG. 1, a three-phase output 140, 142 and 144 of the isolation transformer 86 is provided with corresponding current sensors 146, 148 and 150. In addition, voltage on each phase of the outputs 140, 142 and 144 is monitored at monitor 152 shown in both FIG. 1 and FIG. 2. A low-pass filter 154 eliminates noise and other artifacts which might impair subsequent measurements and logic decisions. The information from low-pass filter 154 is utilized in a calculation 156 of the alternating current, instant power being consumed by the load 12. In addition, a power loss estimation 158 incorporating the estimated power lost internally in the system 10, is summed at 160 to provide an intermediate, instantaneous measurement of the power demanded by the load when a discharge flag 136 has been set. The power requirement is divided at 162 by the number of DC/DC converter-battery assemblies 90, 92; 94, 96; etc., which have been provided in parallel with the DC bus conductors 22, 24 shown in FIG. 1. The resulting calculation represents the average current demanded by the load (i_dd_avr). This calculation can be provided as a digital word through the control area network 118, or as an analog signal (or pulse width modulated signal) 164 for communication through the digital or analog input/outputs 120. In the event that the discharge flag 136 has been set to logical 1, FIG. 4 illustrates at logical switch 166 that the average current demanded by the load (i_dd_avr) is input through a logical current limiter 168 which limits the average demand current by the load to the maximum current which can be supplied by the load inverter 20 or DC/DC converter 94. Thus, the now-limited current demanded by the load is a reference current 170 from which is subtracted the actual current output 172 from the DC/DC converter 94 and battery 92. This sum is subjected to a current regulator 174, an output voltage limiter 176, and is converted through pulse width modulation 178 to a gating control signal 180 for the DC/DC converter 94. The battery 92, through the DC/DC converter 94, now supplies the appropriate current, at the appropriate voltage to the DC bus conductors 22, 24, to restore the instantaneous DC bus voltage detected at voltage sensor 100 to the desired magnitude of 750 volts.

With reference to FIG. 3, the detection of a more serious event (a “USP event”) representing a serious defect in the power supplied by the electrical power source 14 is illustrated. As discussed above, in the event that either the instantaneous DC bus voltage detected at voltage sensor 100 falls below the second DC bus voltage threshold 130 (e.g., below 680 volts); or, the power source voltage on any phase drops significantly below the nominal voltage (e.g., less than 80% of nominal); or other faults such as variations in frequency of phase are detected which are nontransient (i.e., last more than a few seconds), a disjunctive logical decision 182 is made which sets the UPS event flag 184 to a logical 1. In addition, a logical decision 186 is made to disable the source rectifier 18 so as to isolate the system 10 from the power source 14.

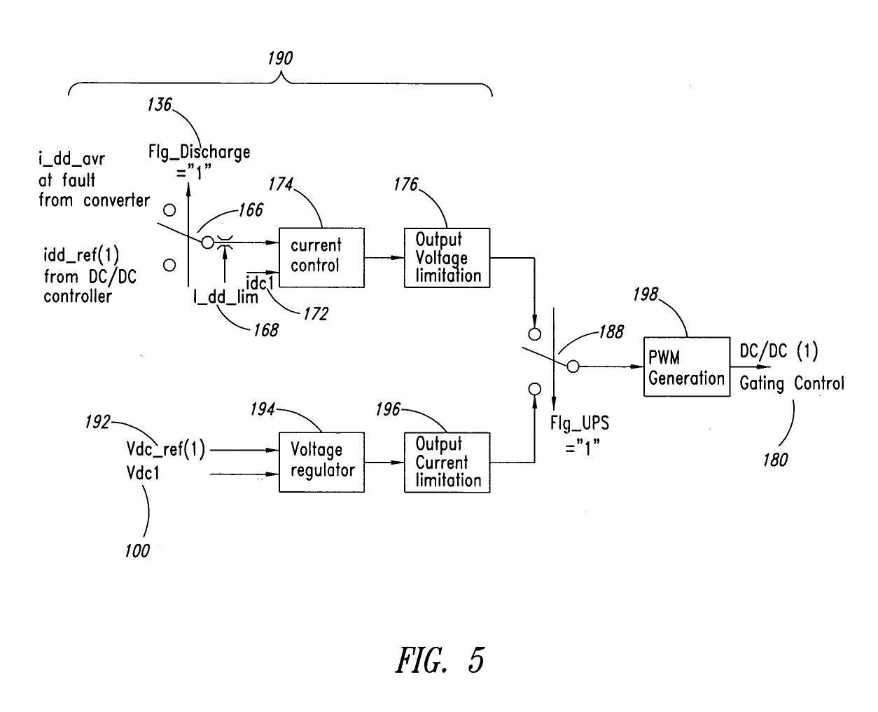

As best seen in FIG. 5, setting the UPS flag to a logical 1 results in setting a logical switch 188 to the downward position in FIG. 5. For purposes of understandability, a portion 190 of the decisional logic in FIG. 4 is repeated in FIG. 5 at the like-numbered references. Nevertheless, with respect to the UPS event flag being set to logical 1, the voltage 192 demanded from the DC bus (internally understood within the system as “Vdc_ref(1)”) as well as the actual voltage appearing on the DC bus detected at voltage sensor 100 are an input to a logical voltage regulator 194 and an output current limiter 196. The resulting information represents the amount of current which must be provided solely by the DC/DC converter 94 and battery 92 to the load inverter 20 through the DC bus to power the load 12. The appropriate gating control signal 180 is communicated to the DC/DC converter 94 by appropriate pulse width modulation 178 through the digital/analog inputs/outputs 120 rather than the slower control area network 118.

It is to be understood that in the event of either a transitory, “discharge event” in which power supplied to the load 12 both by the battery 92 and the source 14, or UPS event in which case power is supplied to the load 12 only by the battery 92 and the system is isolated from the source 14, only the first in the series of DC/DC converter-battery assemblies are utilized until the charge from that assembly is exhausted. The system 10 then selects the next DC/DC converter 96/battery 94 combination to supply power to the DC bus until it is exhausted, or the discharge/UPS event terminates. As shown in FIG. 2, up to nine such combinations, by way of example only, may be connected in parallel to the DC bus (see logic step 162). Thus, the UPS system 10 may continue to operate until each of the combinations, in its own turn, has its charge exhausted.

It will be apparent to those of ordinary skill in the art, upon reviewing the above disclosure, that other embodiments and variations are contemplated. By way of example, not limitation, those of ordinary skill in the art will appreciate that the logical steps described in FIGS. 2-5 may be implemented in a variety of hardware and software configurations including microprocessor, microcontrollers, discrete digital logic elements, or even analog circuitry. That is, the particular implementation of the logic shown and described can be varied to suit the specific application to which such logic is employed. Furthermore, the specific form of the current and voltage sensors disclosed above may be varied according to the preferences of those of ordinary skill in this art. Finally, those of ordinary skill in the art will understand that the batteries 90, 92 may take the form or any rechargeable device which has the capability of outputting direct current. Thus, electrochemical batteries, zinc air batteries, flywheel-motor/generator combinations, etc., may all be employed for the purpose of providing direct current power to the DC bus, and for being recharged through the DC bus from electrical power source 14. Further yet, the embodiment of FIG. 1 discloses an application in which both the source 14 and the load 12 have three phases. The apparatus and methods disclosed herein are equally applicable to dual-phase, single-phase, or more phases, as will suit those of ordinary skill in the art.

From the foregoing it will be appreciated that, although specific embodiments of the present systems and methods have been described herein for purposes of illustration, various modifications may be made without deviating from the spirit and scope of the invention. Thus, the invention is not to be limited by the above disclosure, but is to be determined in scope by the claims which follow.

1. A method for responding to electrical power source irregularities in an uninterruptible power supply system utilizing a rechargeable DC power supply as back up power, comprising:
providing an uninterruptible power supply system comprising a three phase AC source converter connectable to a three phase AC power source and a three phase AC load converter connectable to a three phase load, wherein the converters are interconnected by a DC bus;
monitoring DC bus voltage on the DC bus;
establishing a first DC bus voltage threshold indicative of a first power source irregularity and a second DC bus voltage threshold indicative of a second and distinct power source irregularity, wherein the first threshold is greater than the second threshold;
comparing the DC bus voltage to the first and second thresholds;
commuting electrical power from both the power source and from the DC power supply to the DC bus when the DC bus voltage is intermediate the first and second thresholds; and,
conversely commuting electrical power only from the DC power supply to the DC bus when the DC bus voltage is less than the second threshold, and disabling the source converter.

2. The method of claim 1, wherein the three phase AC power source is a public power grid.

3. The method of claim 2, wherein the first power source irregularity is a transitory power source instability and the second power source irregularity is a power source failure.

4. The method of claim 1, wherein the first power source irregularity is a transitory power source instability and the second power source irregularity is a power source failure.

5. The method of claim 1, further comprising establishing predetermined quality criteria for acceptable power source quality, monitoring power source voltage and current parameters for each phase on an input side of the source converter and commuting electrical power only from the DC power supply to the DC bus and disabling the source converter when the power source voltage fails to meet the predetermined quality criteria indicative of a power source failure.

6. The method of claim 5, further comprising monitoring instantaneous load voltage and current parameters for each phase on an output side of the load converter, calculating a load power demand value from the instantaneous parameters, and when a transient power source irregularity is indicated, generating a command signal to the DC power supply indicative of additional current needed by the load to supplant power lost from the AC power source due to the irregularity.

7. The method of claim 1, further comprising monitoring instantaneous load voltage and current parameters for each phase on an output side of the load converter, calculating a load power demand value from the instantaneous parameters, and when a transient power supply irregularity is indicated, generating a command signal to the DC power supply indicative of additional current needed by the load to supplant power lost from the AC power source due to the irregularity.

8. The method of claim 1, further comprising providing a plurality of rechargeable DC power supplies connected in parallel to each other and to the DC bus, and using power from each DC power supply sequentially when a power source irregularity is indicated.

9. The method of claim 1, wherein the first DC bus voltage threshold is approximately 710 Volts and the second DC bus voltage threshold is approximately 680 Volts.

10. An apparatus for responding to electrical power source irregularities in an uninterruptible power supply system comprising a rechargeable DC power supply interconnected to a DC bus, comprising:
an uninterruptible power supply system comprising a three phase AC source converter connectable to a three phase AC power source and a three phase AC load converter connectable to a three phase load, wherein the converters are interconnected by a DC bus;
means for monitoring DC bus voltage on the DC bus;
establishing means for establishing a first DC bus voltage threshold indicative of a first power source irregularity and a second DC bus voltage threshold indicative of a second and distinct power source irregularity, wherein the first threshold is greater than the second threshold;
comparing means for comparing the DC bus voltage to the first and second thresholds; and
commuting means for commuting electrical power from both the power source and from the DC power supply to the DC bus when the DC bus voltage is intermediate the first and second thresholds, and for conversely commuting electrical power only from the DC power supply to the DC bus when the DC bus voltage is less than the second threshold and for disabling the source converter.

11. The apparatus of claim 10, wherein the three phase AC power source is a public power grid.

12. The apparatus of claim 11, wherein the first power source irregularity is a transitory source instability and the second power source irregularity is a power source failure.

13. The apparatus of claim 10, wherein the first power source irregularity is a transitory power source instability and the second power source irregularity is a power source failure.

14. The apparatus of claim 10, further comprising grid failure establishing means for establishing predetermined quality criteria for acceptable power source quality, power source monitoring means for monitoring source voltage and current parameters for each phase on an input side of the source converter and power source failure commuting means for commuting electrical power only from the DC power supply to the DC bus and disabling the source converter when the source voltage fails to meet the predetermined quality criteria indicative of a power source failure.

15. The apparatus of claim 14, further comprising instantaneous monitoring means for monitoring instantaneous load voltage and current parameters for each phase on an output side of the load converter, load power calculating means for calculating a load power demand value from the instantaneous parameters, transient power supplying means for supplying power to the DC bus from the DC power supply when a transient power source irregularity is indicated, and command signal generating means for generating a command signal to the DC power supply indicative of additional current needed by the load to supplant power lost from the AC power source due to the irregularity.

16. The apparatus of claim 10, further comprising instantaneous monitoring means for monitoring instantaneous load voltage and current parameters for each phase on an output side of the load converter, load power calculating means for calculating a load power demand value from the instantaneous parameters, and command signal generating means for generating a command signal to the DC power supply indicative of additional current needed by the load to supplant power lost from the AC power source due to the irregularity.

17. The apparatus of claim 10, further comprising a plurality of rechargeable DC power supplies connected in parallel to each other and to the DC bus, and sequential DC power control means for using power from each DC power supply sequentially when a power source irregularity is indicated.

18. The apparatus of claim 10, wherein the first DC bus voltage threshold is approximately 710 Volts and the second DC bus voltage threshold is approximately 680 Volts.

19. A method for responding to electrical power source irregularities in an uninterruptible power supply system, comprising:
providing an uninterruptible power supply system comprising an AC source converter connectable to an AC power source and an AC load converter connectable to a load, wherein the converters are interconnected by a DC bus;
interconnecting a rechargeable DC power supply to the DC bus;
monitoring DC bus voltage on the DC bus;
establishing a first DC bus voltage threshold indicative of a first power source irregularity and a second DC bus voltage threshold indicative of a second and distinct power source irregularity, wherein the first threshold is greater than the second threshold;
comparing the DC bus voltage to the first and second thresholds;
commuting electrical power from both the power source and from the DC power supply to the DC bus when the DC bus voltage is intermediate the first and second thresholds; and,
conversely commuting electrical power only from the DC power supply to the DC bus when the DC bus voltage is less than the second threshold, and disabling the source converter.

20. The method of claim 19, further comprising establishing predetermined quality criteria for acceptable power source quality, monitoring power source voltage and current parameters for each phase on an input side of the source converter and commuting electrical power only from the DC power supply to the DC bus and disabling the source converter when the power source voltage fails to meet the predetermined quality criteria indicative of a power source failure.

21. An apparatus for responding to electrical power source irregularities in an uninterruptible power supply system comprising a rechargeable DC power supply interconnected to a DC bus, comprising:
an uninterruptible power supply system comprising a three phase AC source converter connectable to a three phase AC power source and a three phase AC load converter connectable to a three phase load, wherein the converters are interconnected by a DC bus;
a number of voltage sensors coupled to sense DC bus voltage on the DC bus;
a controller configured to compare the DC bus voltage to a first DC bus voltage threshold indicative of a first power source irregularity and a second DC bus voltage threshold indicative of a second and distinct power source irregularity, wherein the first threshold is greater than the second threshold; and further configured to provide control signals to at least one of the three phase AC source converter and the three phase AC load converter to commutate electrical power from both the power source and from the DC power supply to the DC bus when the DC bus voltage is intermediate the first and second thresholds, and for conversely commuting electrical power only from the DC power supply to the DC bus when the DC bus voltage is less than the second threshold and for disabling the source converter.

22. The apparatus of claim 21, wherein the first power source irregularity is a transitory source instability and the second power source irregularity is a power source failure.

23. The apparatus of claim 21, further comprising:
a number of power source voltage sensors coupled to sense a source voltage for each phase on an input side of the source converter, and
a number of power source current sensors coupled to sense a source current for each phase the input side of the source converter, wherein the controller is further configured to commutate electrical power only from the DC power supply to the DC bus and disabling the source converter when the source voltage fails to meet a predetermined quality criteria indicative of a power source failure.

24. The apparatus of claim 23, further comprising:
a number of voltage sensors coupled to instantaneously sense load voltage for each phase on an output side of the load converter,
a number of current sensors coupled to instantaneously sense load current for each phase on an output side of the load converter, wherein the controller is further configured to calculate a load power demand value from the instantaneous load voltage and the instantaneous load current,
a transient power switch selectively operable to couple the DC power supply to the DC bus to supply from the DC power supply when a transient power source irregularity is indicated; wherein the controller is further configured to generate a command signal to the DC power supply indicative of additional current needed by the load to supplant power lost from the AC power source due to the irregularity.

25. The apparatus of claim 21, further comprising:
a plurality of rechargeable DC power supplies connected in parallel to each other and to the DC bus, Wherein the controller is configured to use power from each DC power supply sequentially when a power source irregularity is indicated.
